(19) United States
(12) Patent Application Publication
(10) Pub. No.: US 2021/0347314 A1
(43) Pub. Date: Nov. 11, 2021

(54) Clamping Strap for Mounting a Component

(71) Applicant: NORMA CHINA CO., LTD., Qingdao, Shandong (CN)

(72) Inventors: Jonathan Heywood, Qingdao, Shandong (CN); Minghui Liang, Qingdao, Shandong (CN); Degang Hao, Qingdao, Shandong (CN); Rufei Ma, Qingdao, Shandong (CN)

(21) Appl. No.: 17/278,360

(22) PCT Filed: Sep. 18, 2019
(86) PCT No.: PCT/CN2019/106428

§ 371 Date: Mar. 22, 2021

(30) Foreign Application Priority Data
Sep. 20, 2018 (CN) 201811100756.8

(51) Int. Cl. B60R 16/00

(52) U.S. Cl. CPC B60R 16/00

(57) ABSTRACT

A device for holding a tubular component on a vehicle is proposed. The device includes a bracket, two strap parts and at least two trunnions. Both strap parts on one end include a loop and on an opposed end a connection surface. The bracket includes at least one receiving opening for each trunnion to hold the respective trunnion in the at least one receiving opening. Each loop is dimensioned to allow one of the trunnions to extend through the loop when being placed in the respective at least one receiving opening of the bracket. The connection surfaces are shaped so as to be connectable to each other and to form a closed strap and the bracket includes a holding device for attaching the bracket to the vehicle.

### INTRODUCTION

The disclosure relates to a device for holding a tubular component on a vehicle chassis.

Such a device exemplarily allows to fix exhaust components to a chassis of a vehicle. However, the device will be subjected to significant mechanical loads during its lifetime. This results from the weight of these components, vibrations caused by combustion engine operation and road conditions. For example, a Diesel particle filter may be held by such a device and have a weight of as much as 20 kg. Consequently, suitable devices for holding an exhaust component should have a sufficient durability.

Common devices for holding tubular components, such as exhaust components, comprise a bracket that is to be attached to the vehicle, as well as a strap to be wrapped around the component. The strap is commonly attached to the bracket by welding. However, in some circumstances it may be a challenge to wrap the strap around the component when the bracket is already in place. Also, a welded connection may require an increased accuracy to avoid potentially weakened regions, where a breakage may occur.

### SUMMARY

It is an object per an embodiment of the disclosure to propose a device for holding a tubular component on a vehicle, which allows to provide a reliable and vibration-resistant connection of the tubular component and the vehicle, while the welding of a strap to a bracket shall be avoided and while the assembly shall be as simple as possible.

A device for holding a tubular component on a vehicle is proposed, the device comprising a bracket, two strap parts and at least two trunnions, wherein both strap parts on one end comprise a loop and on an opposed end a connection surface, wherein the bracket comprises at least one receiving opening for each trunnion to hold the respective trunnion in the at least one receiving opening, wherein each loop is dimensioned to allow one of the trunnions to extend through the loop when being placed in the respective at least one receiving opening of the bracket, wherein the connecting surfaces are shaped so as to be connectable to each other so as to form a closed strap and wherein the bracket comprises a holding device for attaching the bracket to the vehicle.

The device is capable of reliably holding a tubular component on a vehicle, while the used components are simple, easy to manufacture, sturdy and reliable. The bracket acts as an interface between the vehicle and the two strap parts, which together hold the tubular component. It is not required to weld the strap parts to the bracket and the strap parts are simply attached through the use of the trunnions.

The bracket may preferably be shaped to provide a smooth radial inner contour of the device, which conforms the radial outer contour of the component to be held to avoid uneven stresses. When describing the shape and the advantages of the bracket, the face of the bracket that touches the tubular component will be referred to as the inner radial face. Consequently, the face opposed thereto in a radial direction will be referred to as the outer radial face. In analogy to this the bracket also comprises axial faces as well as circumferential faces.

Instead of using a single, welded-on strap with two opposed and connectable ends it is proposed to use two separate strap parts, which can be attached to the bracket through a form-fit connection. For this purpose, both strap parts comprise a loop. The loop may be provided through folding or bending an end of the respective strap part about substantially 180°, such that an eye or a lug is created. The end may be folded onto an outer or inner radial surface of the strap part. The resulting two layers of the strap part may be joined together through rivets or spot-on welding, which can be accomplished by simply clamping the two layers together and introducing a welding current for a sufficient period of time. In this regard it is stressed that the operational load exerted onto the welding spots are much lower than what occurs in a welding connection between a bracket and strap in conventional devices.

Both strap parts comprise an end that is opposed to the loop and that comprises a connection surface. In the context of an embodiment of the disclosure, the connection surfaces are to be understood as surfaces or surface sections, which can be connected to each other so as to combine both strap parts to form a closed strap. The strap parts may be preferably adapted to the shape of the tubular component to be fixed. Hence, they may be placed around the component such that the connection surfaces face each other. Preferably, per an embodiment, when the strap parts are in place, the connection surfaces are at a distance to each other. This allows to introduce a clamping force through a tensioning devices, such as a screw or similar, which pulls the connection surfaces to each other.

In an embodiment, the strap parts are flat, belt-like parts, which may be preferably made from a metallic material. The loops may have a drop-like cross-section with a broader end and a narrow end. In an assembled state, the trunnions may extend through the cross-section of the loops at a place near the broader end.

Preferably, per an embodiment, the trunnions have a length that exceeds the width of the loop in an axial direction of the device, i.e. in a direction substantially along a center axis or parallel thereto. By exceeding the width, both opposed ends of the trunnions are capable of protruding over the loop. The ends may engage the bracket in the respective receiving openings. Resultantly, the associated strap part cannot be removed from the bracket anymore, since the loop encloses the respective trunnion. High tensile forces can then be transferred between the strap parts and the bracket.

The trunnions may be realized as elongate parts, which may comprise engagement features at least at one end. For example, one end of the trunnions may comprise a stepped diameter that acts as a mechanical stop for preventing a trunnion to slip through a receiving opening of the bracket in one direction. For example, another end of the trunnions may comprise a thread for receiving a nut. As an alternative, a through-hole arranged perpendicularly to the main extension direction of the trunnion may be used. Other alternate securing elements are conceivable. In particular, per an embodiment, a securing element to provide a mechanical stop for preventing the trunnion to slip through a receiving opening in the other direction may be useful. It may also be possible to design the trunnions in such a way that at least one of the ends may be deformed after inserting it into the respective loop and the bracket, so as to irreversibly providing mechanical stops at both ends.

Due to holding the strap parts in the bracket through trunnions it is easily possible to swivel the strap parts around the trunnions. Placing the strap parts around the component is therefore very easy. Also, by using trunnions that can be inserted into and secure in the brackets the strap parts may be placed on the component to be held and be connected to the bracket afterwards by simply inserting and securing the trunnions. However, the assembled device is extremely durable, allows high tensile forces and can be assembled flexibly.

The holding device of the bracket may be realized in a variety of ways. For example, the holding device may simply be a through-hole, through which a screw, a bolt or another fastening device may be placed, which is able to fix the bracket to a corresponding part on the vehicle. However, also a threaded hole may be provided, which allows to screw a separate fastening device into the bracket. Still further, the bracket itself may be provided with an elongate or a belt-like fastening device that protrudes from the bracket for attachment to the vehicle.

Altogether, the device according to an embodiment of the disclosure provides a simple solution for holding a tubular component on a vehicle without the need of welding metallic straps to a bracket. Also, the assembly procedure is easy, while a reliable operation substantially over the lifetime of the vehicle can be ensured.

In an embodiment, the bracket has a box-like shape, wherein two opposed faces in the circumferential direction of the device are open to lead the strap parts through. The bracket may exemplarily be created by a belt-like part, which is folded to form a box-like shape. In fact, the belt-like part may then constitute a somewhat angular loop. The inner radial face of the bracket will be placed on an outer surface of the tubular component. The strap parts extend from the trunnions along the circumferential direction to enclose the tubular component. Hence, the circumferential faces, i.e. the faces that are positioned and spaced apart along the circumferential direction, are open. They may be open completely or partially, as long as the strap parts may reach outside the bracket.

The bracket may also comprise a radial outer face, into which the holding device is integrated or to which it is attached. When the bracket is placed on the component, the radial outer face faces away from the component. Hence, with the holding device being arranged thereon, the bracket will be placed between the vehicle part, to which the device will be attached, and the component. The radial outer face may preferably be designed to improve the load transfer between the holding device and the component held by the strap parts.

As stated above, in an embodiment the holding device comprises a hole in the radial outer face for inserting a fastening device. The hole may be a through-hole, while the fastening device may comprise a mechanical end stop, to prevent the fastening device from slipping through the hole.

Also, the hole may be a threaded hole and the fastening device may comprise a thread and may be inserted through screwing. In this case it may be secured by a nut or a similar component, which is screwed onto the thread of the fastening device.

In an embodiment, the bracket comprises two axial faces, which each comprise a receiving opening for each trunnion. The axial faces are arranged in a distance to each other along the axial direction. With two receiving openings in the two axial faces for each trunnion, the trunnions may be aligned substantially parallel to the axial direction. Hence, the strap parts that are coupled with the trunnions extend along the circumferential direction. By providing two receiving openings for each trunnion, they may be inserted from one axial side into one of the axial faces to reach an interior space of the bracket, and from there they may be inserted into a corresponding receiving opening in the opposed axial face. With the loops of the strap parts being placed in the bracket, the trunnions extend through the loops and provide a loose form-fit engagement. The trunnions may afterwards be secured to the bracket by a fastening device or by conducting a fastening method to deform at least one end of the trunnions.

Still further, an inner radial face of the bracket may comprise the shape of a segment of a lateral cylinder surface. The inner radial surface may therefore flushly rest on the tubular component to be held by the device according to the disclosure.

As mentioned further above, each strap part may be based on a belt-like workpiece, wherein one end of the workpiece is folded to form the loop of the respective strap part. The loop allows to introduce high tensile forces into the strap parts and still allows a certain movability for simplifying the assembly.

In an embodiment, the trunnions comprise a fastening hole in at least one end section, wherein the fastening hole extends perpendicularly to a main extension direction of the trunnion and wherein the device further comprises a correspondingly dimensioned securing element for each fastening hole of each trunnion. For example, the securing element may be a split pin. The combination of the fastening hole and the split pin or another securing element acts as a fastening device. After inserting the trunnion into a respective receiving opening, the fastening hole should extend to a side that follows along the insertion direction. By inserting and/or arresting the securing element into the fastening hole, it provides the function of a mechanical stop and prevents a movement in a direction opposite to the insertion movement.

In an embodiment, the connection surfaces protrude radially from the strap parts and comprise through-holes for inserting a clamping device. The clamping device may be a simple screw or screwing device, which is insertable through both through-holes of the connection surfaces and which allows applying a tensioning force onto the connection surfaces. Resultantly, the space enclosed by the strap parts can be gradually reduced through the clamping device and the clamping force that acts on the tubular component can be adjusted.

Furthermore, it is indicated that the parts of the device according to an embodiment of the disclosure may be made from a metallic material. This may be reasonable for components that have an elevated temperature during operation of the vehicle, as well as for components having a substantial weight. However, the parts may also be made from a plastic material, which may optionally be fiber reinforced, to save weight, labor and costs.

### BRIEF DESCRIPTION OF THE FIGURES

Further features, details and advantages of embodiments of the disclosure arise from the wording of the claims as well as from the following description of exemplary embodiments on the basis of the drawings. It is shown:

FIG. 1 shows a three-dimensional view of the device according to the disclosure.

FIGS. 2a and 2b show different two-dimensional view of the bracket.

### DETAILED DESCRIPTION

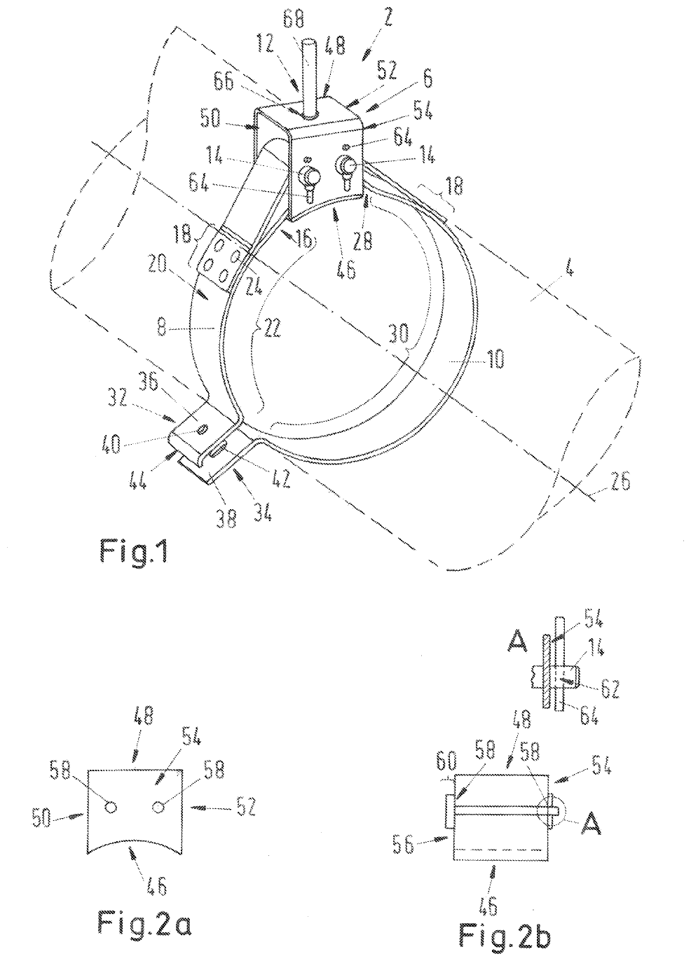

FIG. 1 depicts a device 2 for holding a tubular component 4 on a vehicle (not shown). In this regard it is indicated that the term “tubular” does not necessarily relate to a component, which is completely tubular. Instead, the component to be held may simply comprise a tubular or cylindrical section that is capable of being enclosed by the device 2 according to an embodiment of the disclosure.

The device 2 comprises a bracket 6, a first strap part 8, a second strap part 10, a holding device 12 and two trunnions 14. Both strap parts 8 and 10 are based on a belt-like workpiece, which may preferably be made from a metallic material. The first strap 8 comprises a first loop 16, which is created by folding or bending an end of the first strap about 180°, such that an end section 18 rests flushly on an outer radial surface 20 of a first clamping section 22, which is bent to conform the shape of the component 4. The end section 18 is rigidly connected to the clamping section 22 exemplarily in a number of fastening spots 24, which may be conducted by introducing rivets or by spot-on welding. The loop 16 allows to connect the first strap 8 to the bracket 6 by a trunnion 14, such that high tensile forces can be introduced, while a swiveling motion around the trunnion 14 is still possible. The same principle applies to the second strap part 10, which has a second loop 28 with a similar end section 18 attached to a second clamping section 30.

The first strap part 8 and the second strap part 10 are intended for clamping the tubular component 4. For this, the first strap part 8 comprises a first connection surface 32, which is connectable to a second connection surface 34 arranged at the second strap part 10. In this regard, the connection surfaces 32 and 34 may each belong to a projecting web 36 and 38, respectively and face each other. The webs 36 and 38 each comprise a through-hole 40 and 42, respectively. As an example, the second web 38 comprises an elongate through-hole 42 for compensating manufacturing tolerances of the device 2 or the component 4 for being able to smoothly lead a clamping device (not shown) through both through-holes 40 and 42.

For an optimum alignment of the webs 36 and 38, the first web 36 comprises an outer edge 44 that is folded about 90 degrees towards the second web 38. When the second web 38 is pressed against the first web 36 it cannot move in a radial direction further than the edge 44 allows.

Hence, the device 2 may be wrapped around the tubular component 4 under swiveling the strap parts 8 and 10 radially outwards, placing the device 2 onto the component 4 and swiveling the strap parts 8 and 10 back into place. Afterwards, a clamping device can be inserted into the through-holes 40 and 42 to exert a tensioning force onto the webs 36 and 38 to tighten the device 2 on the component 4. In doing so, the connection surfaces 32 and 34 gradually decrease their distance and the space enclosed by the strap parts 8 and 10 decreases accordingly.

Exemplarily, the bracket 6 has a box shape, which is apparent from the illustration in FIG. 1 as well as from FIGS. 2a and 2b. The bracket 6 comprises a radial inner face 46, a radial outer face 48 opposed thereto, a first circumferential face 50, a second circumferential face 52 opposed thereto, a first axial face 54 and a second axial face 56 opposed thereto. As apparent from FIG. 1 and FIG. 2a, the inner radial face 46 is rounded so as to conform with the curved outer shell of the tubular component 4. The outer radial face 48, at which the holding device 12 is present, is exemplarily flat. For allowing the loops 16 and 28 to reach into an interior space of the bracket 6, the circumferential faces 50 and 52 are open.

Exemplarily, the axial faces 54 and 56 both comprise two receiving openings 58 arranged at a distance to each other. They may preferably be placed in a symmetrical fashion on the axial faces 54 and 56. The receiving openings 58 of both axial faces 54 and 56 are positioned to be directly opposed to the receiving openings 58 of the respective other axial face 56 or 54. Hence, there are two pairs of directly opposed receiving openings 58 for receiving a trunnion 14 in each case.

Both trunnions exemplarily comprise a stepped portion 60 having a diameter larger than the receiving opening 58. Thus, the trunnions 14 can be inserted into one of the receiving openings 58 on one of the axial faces 50 or 52, pushed through one of the loops 16 or 28, when placed in the bracket 6, and afterwards pushed through the opposed receiving opening 58 of the other axial face 52 or 50. The stepped portions 60 stop the trunnions 14 when completely pushed through and placed in the desired locations.

At an end opposite to the stepped portion 60, a fastening hole 62 exemplarily extends through each trunnion 14. The fastening hole 62 is substantially aligned vertically to a main extension direction of the trunnion 14. This allows to put a split pin 64 into the fastening hole 62. After bending at least a section of the split pin 64 the trunnion 14 is secured in place. However, other securing elements are possible.

In the shown example, the outer radial surface 48 comprises a hole 66, through which a fastening device 68 extends. It may be realized as an elongate part that is connectable to the vehicle. However, the fastening device 68 may also be material-bonded to the bracket 6 or secured through a nut at an inner side of the bracket 6 between the loops 16 and 28. Other variants are further conceivable.

The invention is not limited to one of the above-described embodiments but may be modified in a variety of ways.

All features and advantages of the claims that emanate from the description and the drawings, including design details, spatial arrangements and method steps may be essential to the invention both by themselves and in various combinations.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention.

The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE SIGNS

2 device
4 tubular component
6 bracket
8 first strap part
10 second strap part
12 holding device
14 trunnion
16 first loop
18 end section
20 outer radial surface
22 first clamping section
24 fastening spot
26 longitudinal axis
28 second loop
30 second clamping section
32 first connection surface
34 second connection surface
36 first web
38 second web
40 through-hole
42 elongate through-hole
44 outer edge
46 radial inner face
48 radial outer face
50 first circumferential face
52 second circumferential face
54 axial face
56 axial face
58 receiving opening
60 stepped portion
62 fastening hole
64 split pin
66 hole (in the outer radial surface)
68 fastening device

1. A device for holding a tubular component on a vehicle, the device comprising a bracket, two strap parts and at least two trunnions, wherein both strap parts on one end comprise a loop and on an opposed end a connection surface, wherein the bracket comprises at least one receiving opening for each trunnion to hold the respective trunnion in the at least one receiving opening, wherein each loop is dimensioned to allow one of the at least two trunnions to extend through the loop when being placed in the respective at least one receiving opening of the bracket, wherein the connection surfaces are shaped so as to be connectable to each other and to form a closed strap and wherein the bracket comprises a holding device for attaching the bracket to the vehicle.

2. The device of claim 1, wherein the bracket has a box-like shape, wherein two opposed faces in the circumferential direction of the device are open to lead the strap parts through.

3. The device of claim 1, wherein the bracket has a radial outer face, into which the holding device is integrated or to which it is attached.

4. The device of claim 3, wherein the holding device comprises a hole in the radial outer face for inserting a fastening device.

5. The device of claim 1, wherein the bracket comprises two axial faces, which each comprise a receiving opening for each trunnion.

6. The device of claim 1, wherein an inner radial face of the bracket comprises the shape of a segment of a lateral cylinder surface.

7. The device of claim 1, wherein each strap part is based on a belt-like workpiece, wherein one end of the belt-like workpiece is folded to form the loop of the respective strap part.

8. The device of claim 1, wherein the at least two trunnions comprise a fastening hole in at least one end section, wherein the fastening hole extends perpendicularly to a main extension direction of the at least two trunnions, wherein the device further comprises a correspondingly dimensioned fastening element for each fastening hole of each trunnion.

9. The device of claim 1, wherein the connection surfaces protrude radially from the strap parts and comprise through-holes for inserting a clamping device.
